(19) United States
(12) Patent Application Publication
(10) Pub. No.: US 2003/0165409 A1
(43) Pub. Date: Sep. 4, 2003

(54) Device and method for manipulating or dispensing multiple filaments

(75) Inventor: Robert J. Macomber, Phoenix, AZ (US)

Correspondence Address: PILLSBURY WINTHROP, LLP, P.O. BOX 10500, MCLEAN, VA, 22102, US

(73) Assignee: Polymicro Technologies, LLC, Phoenix, AZ

(21) Appl. No.: 10/086,552

(22) Filed: Mar. 4, 2002

(51) Int. Cl. B01L 9/00

(52) U.S. Cl. 422/104; 422/99; 422/100; 436/180

(57) ABSTRACT

A device and method to dispense and manipulate multiple filaments includes at least three plates, each having at least one machined hole designed to accept one or more filaments. Based upon alignment of the machined holes in each of the at least three plates, the plates may be lowered over the top of one or more of the filaments. The position of the plates may be subsequently adjusted with respect to one another so as to secure the filaments in the device without having to individually secure the filaments into the device. Once secured, the filaments may be utilized in a predetermined application of an analytical instrument or dispensing device.

### BACKGROUND OF THE INVENTION

1. Field of the Invention

The invention generally relates to the field of manipulating and dispensing filaments. More particularly, the invention relates to manipulating and dispensing filaments that may be useful in analytical processes.

2. Background Information

Capillary tubes and pipettes are used, for example, in analytical instrument applications, when it is necessary to transfer a fluid from one container or device to a second container. Many techniques have been used, such as spotters, pipettes, and an array of various pumping mechanisms that employ a wide range of materials, to transfer the fluid. In many instances, for example when pipettes are used, the transfer vehicle is designed so that the fluid-handling portion is disposable.

The use of capillary tubing as a filament in analytical applications is well known in the art. Due to the small size of both the internal and external diameter of capillary tubing, a very large number of such filaments may be employed in a relatively small spatial area.

### SUMMARY OF THE INVENTION

In an embodiment of the present invention, a device and method to dispense and manipulate multiple filaments includes at least three plates each having at least one machined hole of a predetermined diameter, and a holding mechanism to orient and support the at least three plates. The at least three plates are configured to adjustably align to one another and may be shifted in a horizontal direction with regard to one another so as to secure the multiple filaments in the device. Once secured, the multiple filaments may be manipulated to permit contact with a sample of an analytical application.

### BRIEF DESCRIPTION OF THE DRAWINGS

The above and other features of the present invention are further described in the detailed description which follows, with reference to the drawings, and by way of a non-limiting exemplary embodiment of the present invention, wherein like reference numerals represent similar parts of the present invention throughout the several views and wherein:

FIG. 1 illustrates a loading position of a device in accordance with an embodiment of the present invention;

FIG. 2 illustrates a locked position of a device in accordance with an embodiment of the present invention;

FIG. 3 illustrates a cross-sectional, top view of an external holder of a device in accordance with an embodiment of the present invention;

FIG. 4 illustrates a device in accordance with another embodiment of the present invention; and

FIG. 5 illustrates a block diagram of the method of the present invention.

### DETAILED DESCRIPTION

The following detailed description of the present invention refers to the accompanying drawings that illustrate exemplary embodiments consistent with this invention. Other embodiments are possible and modifications may be made to the embodiments without departing from the spirit and scope of the invention. Therefore, the following detailed description is not meant to limit the invention. Rather the scope of the invention is defined by the appended claims.

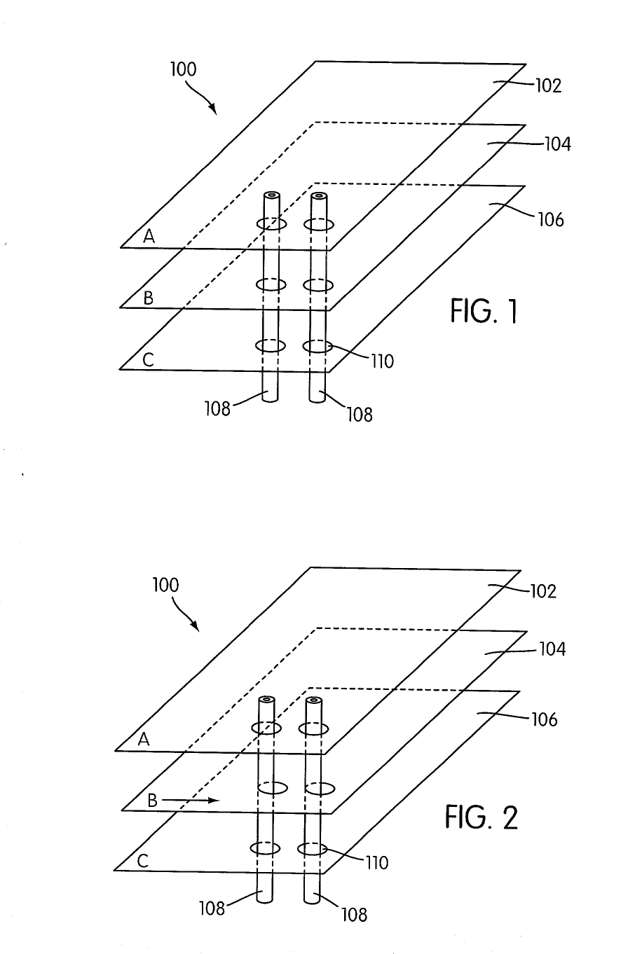

Referring now more particularly to the drawings, FIG. 1 illustrates a loading position of a device 100 in accordance with an embodiment of the present invention. Device 100 includes at least three plates that may be of the same or similar design. For example, at least three plates may have a 96, 384 or 1536 well plate pattern that is known in the art. In FIG. 1, three plates are illustrated as plates A, B and C, 102, 104 and 106 respectively. Each plate, A, B and C, has at least one hole 110 of a predetermined diameter that is machined on the plate in order to accept a filament 108. Each filament 108 may be, for example, capillary tubing, light guiding capillary tubing, optical fiber, glass or polymeric rods, disposable pipette tips, or wire. Plates A, B and C, 102, 104 and 106 respectively, may be arranged such that plate B 104 is 180° in rotation to plates A and C, 102 and 106 respectively. This configuration would permit a single plate design to be used for plates A, B and C, 102, 104 and 106. Based upon the alignment of the hole 110, the plates 102, 104 and 106 may be aligned and lowered over the top of one or more filaments 108 so as to load or unload the filaments. When the hole 110 is substantially aligned, the filaments may move freely in a vertical direction.

FIG. 2 illustrates the plates of the device in a locked position. Prior to locking, filaments 108 may be fed through machined holes 110 of plates 102, 104 and 106. In order to lock the filaments in position, plate B, 104, may be, moved horizontally with respect to plates A and C, 102 and 106 such that the holes 110 of plate B, 104 are not in alignment with the holes 110 of plates A and C, 102 and 106 respectively. The motion of plate B 104 places a slight non-coaxial load on each filament 108, which secures the filament 108 in place with respect to the plates 102, 104, and 106. Plate B, 104 may be made of the same or different composition as plate A, 102 and plate C, 106. In addition, plate B, 104 may be composed of multiple materials as needed to uniformly distribute the non-coaxial load on each filament 108.

Once the multiple filaments, such as filament 108, are in a locked position, such as that illustrated in FIG. 2, device 100 may be used to manipulate or move the multiple filaments to various positions, for example, into or out of analytical instruments or fluid supplies. Device 100 may also dispense filaments 108 into a secondary holder or apparatus. Filament 108 may be unloaded by, for example, moving plate B 104 back to its original position with respect to plates A and C, 102 and 106, which releases the non-coaxial load on the filaments 108. Device 100 may also transfer liquid reagents, via filaments 108, by dripping and spotting or filling and then dispensing. Additionally, filaments 108 may be cleaned and reused without the need to remove the filaments 108 from device 100. As a result, device 100 may be used multiple times so as to be most cost effective.

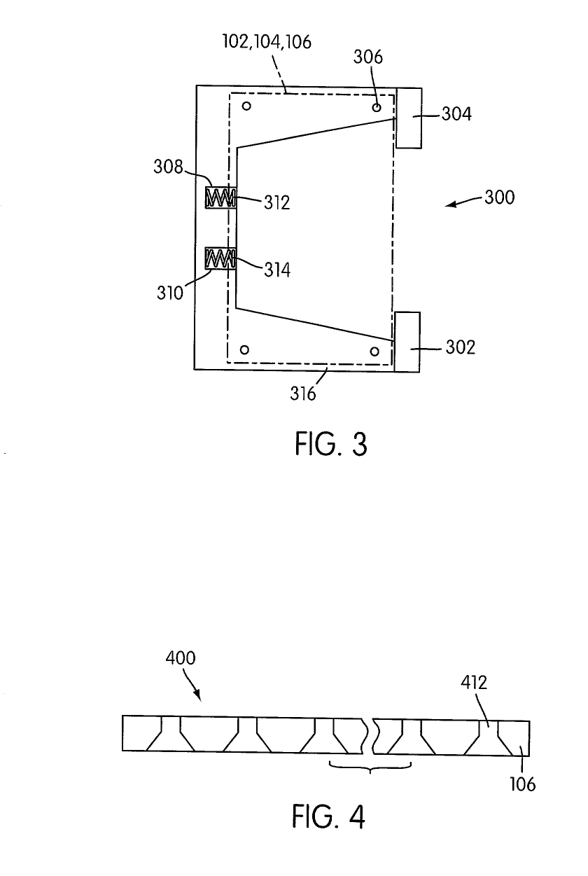

FIG. 3 illustrates a cross-sectional, top view of an external holder of the device of FIGS. 1 and 2 in accordance with an embodiment of the present invention. External holder 316 may function to hold the at least three plates A, B and C in a particular orientation and position with respect to one another. The cross-sectional top-view of FIG. 3 illustrates plate B 104 as being fixed in the external holder 316. Plates A and C, which are not illustrated, may be positioned one plate above and one plate below plate B. The external holder 316 may be of a C-shaped design and includes removable holder caps 302, 304. External holder 316 may also include pins 306 for aligning the filaments in the external holder 316, and a mechanism, for example, springs 312 and 314, that are configured to actuate plate B into the locked or loaded position illustrated in FIG. 2. Springs 312 and 314 may be actuated manually or via robotic automation. The tension of springs 312 and 314 may be adjustable via setscrews 308, 310 applied to plate B. The adjustable tension would be evenly distributed over the loaded filaments to secure them into position. The removable holder caps 302 and 304 may be removed in order to disassemble the device for cleaning or replacement of one or more of the plates in the device.

FIG. 4 illustrates an additional embodiment of the present invention in which a cross-sectional view of one of the at least three plates is depicted. In FIG. 4, the bottom surface of plate C 106 is machined with a chamfer 412 to facilitate the alignment and loading of the filaments into the device. Although the bottom surface of plate C 106 is illustrated in FIG. 4, either the top or bottom surfaces of one or more of the plates A, B and C, 102, 104 and 106 respectively, may be machined with a chamfer in order to facilitate the engagement of the filaments into the device. All other functions of the embodiment of FIG. 4 are the same as illustrated in FIGS. 1 and 2.

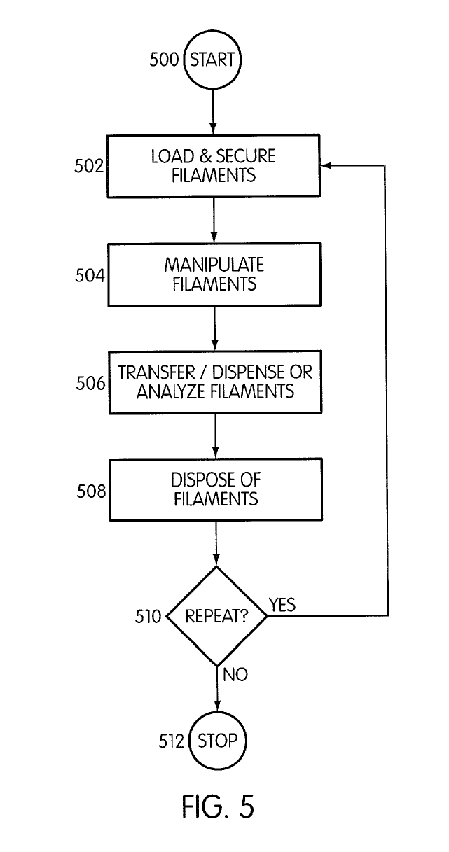

FIG. 5 illustrates a block diagram of a method of manipulating and dispensing filaments in accordance with the present invention. The process begins at 500 and continues to block 502.

At 502, filaments are loaded and secured in a device having at least three plates as discussed above with respect to FIGS. 1 and 2. The filaments may be, for example, capillary tubing, light guiding capillary tubing, optical fiber, glass or polymeric rods, disposable pipette tips or wire, that are loaded into the plates having a design pattern. The design pattern may correspond, for example, with a 96, 384 or 1536 well plate pattern having machined holes thereon. The secured filaments and device form a single, movable unit. The patterns for the plates are selected based upon a design that corresponds to the device, such as a well plate, that contains samples that may be used in an analytical application. The process continues to block 504.

At 504, the device and secured filaments are manipulated so as to allow the filaments to come into contact with the samples for use in the analytical application such that a controlled amount of the sample may be drawn into or adhere to the filaments. The process continues to block 506.

At block 506, the samples for use in the analytical application may be transferred, dispensed or further analyzed using methods known to those skilled in the art. The process continues to block 508.

At block 508, upon completion of transfer, dispensing or further analysis, the device may be placed in the unload position to dispose of the filaments or clean the filaments for re-use. The process continues to block 510.

At block 510, it is determined whether it is necessary to continue the predetermined analytical application. If it is necessary to repeat or perform another analytical application, then the process returns to block 502. At block 502, a second set of filaments may be loaded and secured into the device or the cleaned filaments may be re-loaded into the device. If no further analytical applications need to be performed, then the process ends at block 512.

The foregoing description of the embodiments of the present invention provides illustration and description, but is not intended to be exhaustive or to limit the invention to the precise form disclosed. Modifications and variations are possible consistent with the above teachings or may be acquired from practice of the invention. For example, the various features of the invention, which are described in the contexts of separate embodiments for the purposes of clarity, may also be combined in a single embodiment. Conversely, the various features of the invention which are, for brevity, described in the context of a single embodiment may also be provided separately or in any suitable sub-combination. Accordingly, persons skilled in the art will appreciate that the present invention is not limited to what has been particularly shown and described hereinabove. Rather, the scope of the present invention is defined only by the attached claims and their equivalents.

What is claimed is:

1. A device for manipulating and dispensing multiple filaments, comprising:
at least three plates each having at least one machined hole of a predetermined diameter, wherein the at least three plates are configured to adjustably align to one another, and at least one of the at least three plates may be shifted in a horizontal direction with regard to the remaining plates to secure the multiple filaments in the device; and
a holding mechanism configured to orient and support the at least three plates.

2. The device of claim 1, wherein the at least one machined hole is configured to permit unrestricted passage of a plurality of filaments in a vertical direction.

3. The device of claim 2, wherein the plurality of filaments are capillary tubes.

4. The device of claim 2, wherein the plurality of filaments are optical fibers.

5. The device of claim 2, wherein the plurality of filaments are light guiding capillary tubing.

6. The device of claim 1, wherein a plate pattern of the at least three plates corresponds to one of a 96, 384 and 1536 well plate design pattern.

7. The device of claim 1, wherein the holding mechanism comprises:
at least one tension device configured to actuate at least one of the at least three plates into one of a locked and unlocked position; and
holder means configured to secure the at least three plates into the device.

8. The device of claim 7, wherein the at least one tension device is adjustable.

9. The device of claim 1, wherein at least one surface of at least one of the least three plates is machined with a chamfer.

10. A method for manipulating and dispensing filaments, comprising:
loading a plurality of filaments in machined holes of a device having at least three plates;
shifting at least one of the at least three plates in a horizontal direction with respect to the remaining plates to secure the plurality of filaments into the device; and
manipulating the plurality of filaments to permit contact with a sample of an analytical application.

11. The method of claim 10, further comprising:
analyzing the samples of the analytical application; and
unloading the plurality of filaments from the device.

12. The method of claim 11, wherein analyzing the samples includes at least one of transferring and dispensing the samples of the analytical application.

13. The method of claim 11, wherein unloading the plurality of filaments includes shifting at least one plate in a horizontal direction with respect to the remaining plates to release the plurality of filaments from the device.

14. The method of claim 13, wherein unloading the plurality of filaments further includes one of disposing of the plurality of filaments and cleaning the plurality of filaments for re-use.
